(19) United States
(12) Patent Application Publication
(10) Pub. No.: US 2018/0028981 A1
(43) Pub. Date: Feb. 1, 2018

(54) FILTRATION UNIT

(71) Applicant: SUMITOMO ELECTRIC INDUSTRIES, LTD., Osaka-shi, Osaka (JP)

(72) Inventors: Hiromu TANAKA, Osaka (JP); Hiroko MIKI, Osaka (JP); Tomoyuki YONEDA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 15/551,361

(22) PCT Filed: Feb. 18, 2016
(86) PCT No.: PCT/JP2016/054631

§ 371 Date: Aug. 16, 2017

(30) Foreign Application Priority Data
Mar. 24, 2015 (JP) 2015-061772

(51) Int. Cl. B01D 65/02; C02F 1/44; B01D 63/04

(52) U.S. Cl. CPC B01D 65/02; B01D 63/04; C02F 1/44; B01D 2321/18; B01D 2319/04; C02F 2303/16

(57) ABSTRACT

A filtration unit includes a plurality of filtration modules and a piping unit. Each filtration module includes a plurality of hollow fiber membranes extending in a vertical direction and arranged side by side in a form of a plate, and a first water collector having a linear shape that is connected to upper openings of the hollow fiber membranes and through which filtered liquid that has permeated into each hollow fiber membrane flows. The piping unit is connected to the first water collectors of the filtration modules. The filtration modules are arranged in two rows and in a striped pattern in each row. The piping unit includes two combining pipes that are arranged parallel to each other and that are connected to outer end portions of the first water collectors of the filtration modules in each row by first connection pipes.

### TECHNICAL FIELD

The present invention relates to a filtration unit.

### BACKGROUND ART

Filtration units including filtration modules, in which a plurality of hollow fiber membranes are bundled, are used as solid-liquid separation treatment apparatuses in sewage treatment and processes for producing pharmaceuticals and the like.

Such a filtration unit is immersed in a liquid to be treated when used, and performs a filtration process by blocking impurities contained in the liquid to be treated at the surfaces of the hollow fiber membranes and allowing components other than the impurities to permeate into the hollow fiber membranes.

As described in, for example, Japanese Unexamined Patent Application Publication No. 2013-56346, the filtration unit includes a plurality of filtration modules, each including a plurality of hollow fiber membranes extending in a vertical direction and arranged side by side and a water collector (water collecting header) connected to upper openings of the hollow fiber membranes. The filtration unit is configured such that filtered liquid that has permeated into the hollow fiber membranes is collected in the water collector and the filtered liquid collected in the water collector can be extracted through a piping unit connected to a central portion of an upper wall of the water collector.

### CITATION LIST

### Patent Literature

PTL 1: Japanese Unexamined Patent Application Publication No. 2013-56346

### SUMMARY OF INVENTION

### Technical Problem

In the above-described filtration modules, the hollow fiber membranes connected to portions closer to the connecting portion between the water collector and the piping unit have higher operating ratios. Therefore, in the above-described filtration unit according to the related art, dirt relatively easily adheres to the surfaces of the hollow fiber membranes connected to portions close to the central portion of the upper wall of the water collector. Thus, in the above-described filtration modules according to the related art, dirt easily adheres to the surfaces of the hollow fiber membranes that are arranged around the center of the bundle of the hollow fiber membranes.

In the above-described filtration modules according to the related art, the hollow fiber membranes are densely arranged. In addition, in the filtration unit according to the related art, the filtration modules are generally also densely arranged. Therefore, it is not easy to clean the central region of each bundle of the hollow fiber membranes in the filtration unit according to the related art.

The present invention has been made in light of the above-described circumstances, and its object is to provide a filtration unit that enables hollow fiber membranes to be cleaned with increased efficiency.

### Solution to Problem

To solve the above-described problem, a filtration unit according to an embodiment of the present invention includes a plurality of filtration modules and a piping unit. Each filtration module includes a plurality of hollow fiber membranes extending in a vertical direction and arranged side by side in a form of a plate, and a first water collector having a linear shape that is connected to upper openings of the hollow fiber membranes and through which filtered liquid that has permeated into each hollow fiber membrane flows. The piping unit is connected to the first water collectors of the filtration modules. The filtration modules are arranged in two rows and in a striped pattern in each row. The piping unit includes two combining pipes that are arranged parallel to each other and that are connected to outer end portions of the first water collectors of the filtration modules in each row by first connection pipes.

### Advantageous Effects of Invention

The filtration unit according to the present invention enables the hollow fiber membranes to be cleaned with increased efficiency.

### BRIEF DESCRIPTION OF DRAWINGS

FIG. 1 is a schematic perspective view of a filtration unit according to an embodiment of the present invention.

FIG. 2 illustrates the positional relationship between filtration modules arranged adjacent to each other in each row, diffuser tubes, and guide structures in the filtration unit illustrated in FIG. 1.

FIG. 3 is a schematic front view of a filtration module included in the filtration unit illustrated in FIG. 1.

FIG. 4 is a schematic side view of the filtration module illustrated in FIG. 3.

FIG. 5 is a schematic sectional view of the filtration module illustrated in FIG. 3 taken along a plane perpendicular to axes of hollow fiber membranes.

FIG. 6 is a schematic enlarged partial sectional view of the filtration module illustrated in FIG. 3.

### DESCRIPTION OF EMBODIMENTS

### [Description of Embodiments of Present Invention]

Embodiments of the present invention will now be described.

A filtration unit according to an embodiment of the present invention includes a plurality of filtration modules and a piping unit. Each filtration module includes a plurality of hollow fiber membranes extending in a vertical direction and arranged side by side in a form of a plate, and a first water collector having a linear shape that is connected to upper openings of the hollow fiber membranes and through which filtered liquid that has permeated into each hollow fiber membrane flows. The piping unit is connected to the first water collectors of the filtration modules. The filtration modules are arranged in two rows and in a striped pattern in each row. The piping unit includes two combining pipes that are arranged parallel to each other and that are connected to outer end portions of the first water collectors of the filtration modules in each row by first connection pipes.

In the filtration unit, since the piping unit is connected to the outer end portions of the first water collectors, the hollow fiber membranes connected to portions of the first water collectors near the outer end portions tend to have high operating ratios. Therefore, in the filtration unit, the hollow fiber membranes connected to portions of the first water collectors near the outer end portions are easily soiled. In this regard, since the hollow fiber membranes that are easily soiled are arranged in the outer regions of the filtration modules in the filtration unit, the hollow fiber membranes that are easily soiled can be easily cleaned even when the filtration modules are installed in the filtration unit. Thus, the filtration unit enables the hollow fiber membranes to be cleaned with increased efficiency.

Each filtration module may include a second water collector having a linear shape that is connected to lower openings of the hollow fiber membranes and through which the filtered liquid that has permeated into each hollow fiber membrane flows, and the piping unit may include a plurality of second connection pipes that are connected between the outer end portions of the first water collectors of the filtration modules and outer end portions of the second water collectors of the filtration modules. When the piping unit includes the second connection pipes that are connected between the outer end portions of the first water collectors of the filtration modules and the outer end portions of the second water collectors of the filtration modules, the filtered liquid can be extracted not only from the first water collectors but also from the second water collectors, and the efficiency of the filtration process can be increased. In addition, since the second connection pipes are also connected to the first water collectors, the filtered liquid collected by the second water collectors can be extracted through the same path as the path through which the filtered liquid collected by the first water collectors is extracted. Accordingly, the number of components can be reduced, so that the structure can be simplified and the cost can be reduced.

The piping unit may include an extraction pipe connected to the two combining pipes. When the piping unit includes the extraction pipe connected to the two combining pipes, the filtered liquid can be extracted with increased efficiency.

A plurality of diffuser tubes and a ventilation mechanism may be additionally provided. The diffuser tubes are disposed below the filtration modules and have a plurality of through holes from which gas is ejected. The ventilation mechanism force-feeds the gas to the diffuser tubes. When the diffuser tubes disposed below the filtration modules and the ventilation mechanism that force-feeds the gas to the diffuser tubes are provided, the impurities that adhere to the surfaces of the hollow fiber membranes can be easily and reliably removed by the gas ejected from the diffuser tubes. As a result, the cleaning efficiency can be further increased.

A plurality of guide structures may be additionally provided. The guide structures are disposed between the diffuser tubes and the filtration modules, and guide the gas ejected from the diffuser tubes to spaces between the filtration modules. When the guide structures that guide the gas ejected from the diffuser tubes to the spaces between the filtration modules are provided, the impurities that adhere to the surfaces of the hollow fiber membranes can be more easily and reliably removed.

The guide structures may be configured to intermittently eject bubbles. When the guide structures are configured to intermittently eject bubbles, the impurities that adhere to the surfaces of the hollow fiber membranes can be more efficiently removed.

The filtration unit may include a cover that surrounds the filtration unit in a vertical direction. When the filtration unit includes the cover that surrounds the filtration unit in the vertical direction, the gas ejected from the diffuser tubes can be trapped inside the cover so that the impurities that adhere to the surfaces of the hollow fiber membranes can be more efficiently removed.

In this description, the phrase “hollow fiber membranes are arranged in the form of a plate” means that a presence region in which the hollow fiber membranes that constitute a single filtration module are present has a rectangular shape in which two adjacent sides have different lengths. In addition, “outer” means closer to the ends of the water collectors, and “inner” means the opposite of that. Also, “parallel” means that the angle between the central axes is in the range of 0°±10°, and preferably in the range of 0°±5°.

### [Details of Embodiments of Present Invention]

A filtration unit according to an embodiment of the present invention will be described with reference to the drawings.

### [Filtration Unit]

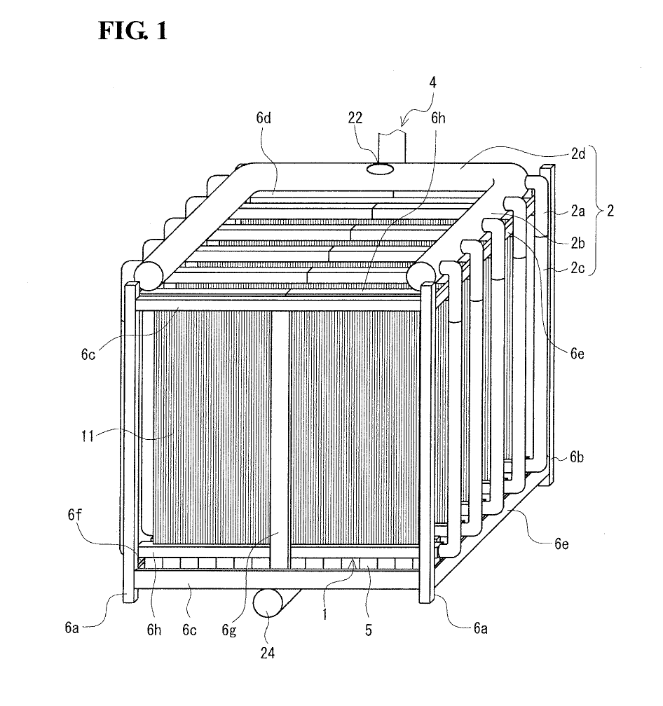

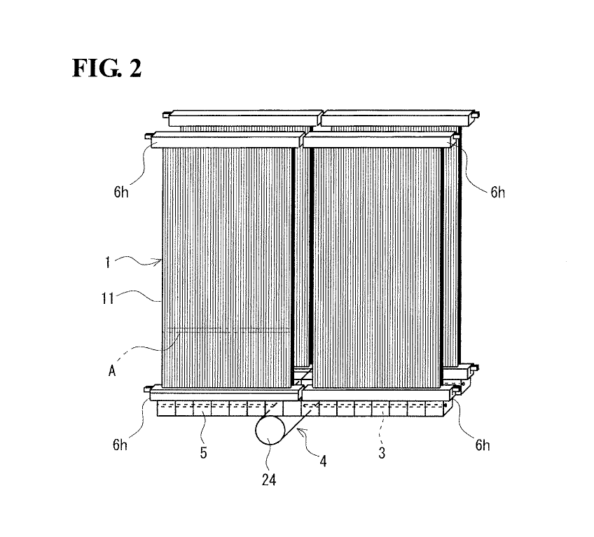

The filtration unit is immersed in a liquid to be treated when used. As illustrated in FIGS. 1 and 2, the filtration unit mainly includes a plurality of filtration modules 1, a piping unit 2, a plurality of diffuser tubes 3, a ventilation mechanism 4, and a plurality of guide structures 5. The filtration unit also includes a plurality of frames 6a to 6h that form a support structure of the filtration unit.

The frames 6a to 6h that form the support structure of the filtration unit include a pair of front vertical frames 6a and a pair of rear vertical frames 6b, which extend in the vertical direction and form four corners of the support structure in plan view; and a pair of front horizontal frames 6c, a pair of rear horizontal frames 6d, a pair of right horizontal frames 6e, and a pair of left horizontal frames 6f, which are arranged in a rectangular shape in plan view and extend between upper portions of the front vertical frames 6a and the rear vertical frames 6b and between lower portions of the front vertical frames 6a and the rear vertical frames 6b.

The frames 6a to 6h also include a pair of support frames 6g that extend between central portions of the pair of front horizontal frames 6c in the axial direction and between central portions of the pair of rear horizontal frames 6d in the axial direction.

The frames 6a to 6h also include a plurality of pairs of module support frames 6h that extend between the right horizontal frames 6e and the left horizontal frames 6f and support the filtration modules 1 at the top and bottom.

### <Filtration Modules>

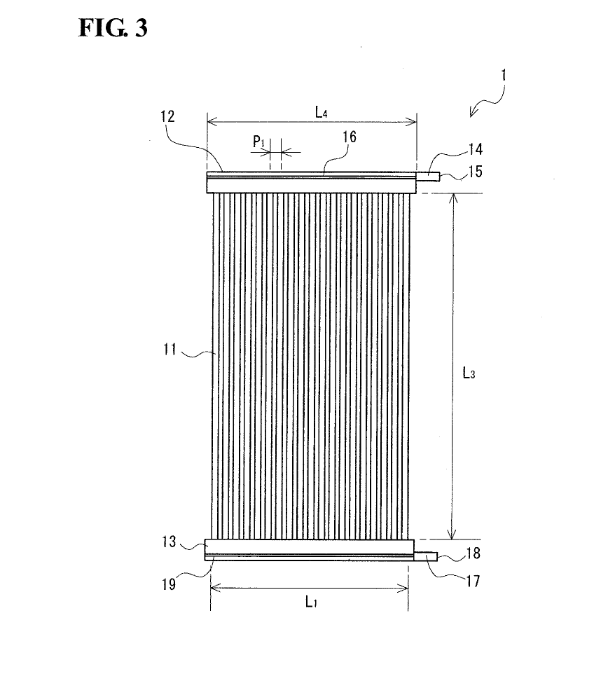

As illustrated in FIGS. 3, 4, and 6, each filtration module 1 includes a plurality of hollow fiber membranes 11 extending in a vertical direction and arranged side by side in the form of a plate; a first water collector 12 having a linear shape that is connected to upper openings of the hollow fiber membranes 11 and through which filtered liquid that has permeated into each hollow fiber membrane 11 flows; and a second water collector 13 having a linear shape that is connected to lower openings of the hollow fiber membranes 11 and through which the filtered liquid that has permeated into each hollow fiber membrane 11 flows.

As illustrated in FIGS. 1 and 2, the filtration modules 1 are arranged in two rows and in a striped pattern in each row. More specifically, as illustrated in FIGS. 2 to 4, a presence region A in which the hollow fiber membranes 11 that constitute a single filtration module 1 are present has a rectangular shape in plan view, and the filtration modules 1 are arranged in two rows so that long sides of the presence regions A are parallel. The filtration modules 1 are at the same positions in the short-side direction of the presence regions A in each row. The filtration modules 1 are arranged with constant gaps therebetween in the short-side direction of the presence regions A. Accordingly, the filtration modules 1 and the spaces between the filtration modules 1 form a striped pattern in each row. The “presence region A” is an imaginary polygon that encloses all of the hollow fiber membranes 11 included in a single filtration module 1 and that has the smallest area when viewed in the axial direction. Preferably, the hollow fiber membranes 11 are arranged in the long-side direction and the short-side direction of the presence regions A in the form of a matrix.

### (Hollow Fiber Membranes)

The hollow fiber membranes 11 are tubes formed of porous membranes that allow water to permeate therethrough and prevent impurities contained in the liquid to be treated from permeating therethrough.

The hollow fiber membranes 11 may contain a thermoplastic resin as a main component thereof. Examples of the thermoplastic resin include polyethylene, polypropylene, polyvinylidene difluoride, an ethylene-vinyl alcohol copolymer, polyamide, polyimide, polyetherimide, polystyrene, polysulfone, polyvinyl alcohol, polyphenylene ether, polyphenylene sulfide, cellulose acetate, polyacrylonitrile, and polytetrafluoroethylene (PTFE). Among these thermoplastic resins, PTFE, which has high chemical resistance, heat resistance, weather resistance, and incombustibility and which is porous, is preferable, and uniaxially or biaxially stretched PTFE is more preferable. The material of the hollow fiber membranes 11 may contain, for example, another polymer and an additive such as a lubricant as appropriate.

The lower limit of the average length L₁ of the presence regions A in the long-side direction is preferably 300 mm, and more preferably, 500 mm. The upper limit of the average length L₁ is preferably 1200 mm, and more preferably, 1000 mm. When the average length L₁ is below the lower limit, sufficient filtration efficiency cannot be obtained. When the average length L₁ is above the upper limit, handling can be difficult.

The lower limit of the average length L₂ of the presence regions A in the short-side direction is preferably 10 mm, and more preferably, 15 mm. The upper limit of the average length L₂ is preferably 100 mm, and more preferably, 75 mm. When the average length L₂ is below the lower limit, sufficient filtration efficiency cannot be obtained. When the average length L₂ is above the upper limit, gas ejected from the diffuser tubes 3, which will be described below, cannot be appropriately supplied to the central portions of the bundles of the hollow fiber membranes 11.

The lower limit of the ratio of the average length L₂ of the presence regions A in the short-side direction to the average length L₁ of the presence regions A in the long-side direction (L₂/L₁) is preferably 1/80, and more preferably, 1/50. The upper limit of the ratio of the average length L₂ to the average length L₁ (L₂/L₁) is preferably 1/3, and more preferably, 1/10. When the ratio of the average length L₂ to the average length L₁ (L₂/L₁) is below the lower limit, t handling of the filtration modules 1 can be difficult. When the ratio of the average length L₂ to the average length L₁ (L₂/L₁) is above the upper limit, the gas ejected from the diffuser tubes 3 cannot be appropriately supplied to the central portions of the bundles of the hollow fiber membranes 11.

The lower limit of the average interval between the presence regions A of the filtration modules 1 that are adjacent to each other in the front-rear direction in each row is preferably 10 mm, and more preferably, 15 mm. The upper limit of the average interval between the presence regions A is preferably 30 mm, and more preferably, 25 mm. When the average interval between the presence regions A is below the lower limit, it can be difficult to appropriately guide the gas ejected from the diffuser tubes 3, which will be described below, to the spaces between the filtration modules 1. When the average interval between the presence regions A is above the upper limit, the density of the filtration modules 1 can be reduced and the filtration efficiency can be reduced accordingly.

The average pitch P₁ of the hollow fiber membranes 11 in the long-side direction is preferably greater than the average pitch P₂ of the hollow fiber membranes 11 in the short-side direction. The lower limit of the ratio of the average pitch P₂ of the hollow fiber membranes 11 in the short-side direction to the average pitch P₁ of the hollow fiber membranes 11 in the long-side direction (P₂/P₁) is preferably 2/5, and more preferably, 1/2. The upper limit of the ratio of the average pitch P₂ of the hollow fiber membranes 11 in the short-side direction to the average pitch P₁ of the hollow fiber membranes 11 in the long-side direction (P₂/P₁) is preferably 4/5, and more preferably, 2/3. When the ratio (P₂/P₁) is below the lower limit, the density of the hollow fiber membranes 11 in the long-side direction can be reduced and sufficient filtration efficiency cannot be obtained. When the ratio (P₂/P₁) is above the upper limit, the gas ejected from the diffuser tubes 3 cannot be sufficiently guided to the spaces between the hollow fiber membranes 11 from one end in the short-side direction.

The lower limit of the filling area ratio of the hollow fiber membranes 11 in the presence regions A is preferably 20%, and more preferably, 30%. The upper limit of the filling area ratio of the hollow fiber membranes 11 in the presence regions A is preferably 60%, and more preferably, 55%. When the filling area ratio of the hollow fiber membranes 11 is below the lower limit, the number of hollow fiber membranes 11 per unit area can be reduced and sufficient filtration efficiency cannot be obtained. When the filling area ratio of the hollow fiber membranes 11 is above the upper limit, the gaps between the hollow fiber membranes 11 can be excessively small and the gas ejected from the diffuser tubes 3 cannot be sufficiently supplied to the central portions of the bundles of the hollow fiber membranes 11.

The lower limit of the number of hollow fiber membranes 11 arranged in each presence region A in the short-side direction (arrangement number) is preferably 8, and more preferably, 12. The upper limit of the number of hollow fiber membranes 11 arranged in the short-side direction is preferably 50, and more preferably, 40. When the number of hollow fiber membranes 11 arranged in the short-side direction is below the lower limit, sufficient filtration efficiency per unit area cannot be obtained. When the number of hollow fiber membranes 11 arranged in the short-side direction is above the upper limit, the gas ejected from the diffuser tubes 3 cannot be appropriately supplied to the central portions of the bundles of the hollow fiber membranes 11.

The lower limit of the ratio of the average pitch P₂ in the short-side direction to the average outer diameter of the hollow fiber membranes 11 is preferably 1. The upper limit of the ratio of the average pitch P₂ in the short-side direction to the average outer diameter of the hollow fiber membranes 11 is preferably 3/2, and more preferably, 7/5. When the ratio of the average pitch P₂ in the short-side direction to the average outer diameter of the hollow fiber membranes 11 is below the lower limit, the hollow fiber membranes 11 are arranged in such a state that the hollow fiber membranes 11 are compressed in the radial direction. Therefore, it can be difficult to manufacture the filtration modules 1. When the ratio of the average pitch P₂ in the short-side direction to the average outer diameter of the hollow fiber membranes 11 is above the upper limit, the density of the hollow fiber membranes 11 in the short-side direction can be reduced and sufficient filtration efficiency cannot be obtained.

The lower limit of the average outer diameter of the hollow fiber membranes 11 is preferably 1 mm, more preferably, 1.5 mm, and still more preferably, 2 mm. The upper limit of the average outer diameter of the hollow fiber membranes 11 is preferably 6 mm, more preferably, 5 mm, and still more preferably, 4 mm. When the average outer diameter of the hollow fiber membranes 11 is below the lower limit, the mechanical strength of the hollow fiber membranes 11 can be insufficient. When the average outer diameter of the hollow fiber membranes 11 is above the upper limit, the flexibility of the hollow fiber membranes 11 can be insufficient and the hollow fiber membranes 11 cannot be sufficiently vibrated or shook when the gas comes into contact therewith. As a result, the gaps between the hollow fiber membranes 11 cannot he increased to guide the gas to the central portions of the bundles of the hollow fiber membranes 11. The ratio of the surface area of the hollow fiber membranes 11 to the cross sectional area of the hollow fiber membranes 11 can be reduced and the filtration efficiency can be reduced accordingly.

The lower limit of the average inner diameter of the hollow fiber membranes 11 is preferably 0.3 mm, more preferably, 0.5 mm, and still more preferably, 0.9 mm. The upper limit of the average inner diameter of the hollow fiber membranes 11 is preferably 4 mm, and more preferably, 3 mm. When the average inner diameter of the hollow fiber membranes 11 is below the lower limit, the pressure loss that occurs when the filtered liquid is discharged from the hollow fiber membranes 11 can be increased. When the average inner diameter of the hollow fiber membranes 11 is above the upper limit, the thickness of the hollow fiber membranes 11 can be reduced and the mechanical strength and impurity blocking effect can be insufficient.

The lower limit of the ratio of the average inner diameter to the average outer diameter of the hollow fiber membranes 11 is preferably 3/10, and more preferably, 2/5. The upper limit of the ratio of the average inner diameter to the average outer diameter of the hollow fiber membranes 11 is preferably 4/5, and more preferably, 3/5. When the ratio of the average inner diameter to the average outer diameter of the hollow fiber membranes 11 is below the lower limit, the thickness of the hollow fiber membranes 11 can be excessively increased and the water permeability of the hollow fiber membranes 11 can be reduced. When the ratio of the average inner diameter to the average outer diameter of the hollow fiber membranes 11 is above the upper limit, the thickness of the hollow fiber membranes 11 can be reduced and the mechanical strength and impurity blocking effect can be insufficient.

The lower limit of the average effective length L₃ of the hollow fiber membranes 11 is preferably 1 m, and more preferably, 2 m. The upper limit of the average effective length L₃ of the hollow fiber membranes 11 is preferably 6 m, and more preferably, 5 m. When the average effective length L₃ of the hollow fiber membranes 11 is below the lower limit, the hollow fiber membranes 11 cannot be sufficiently shook by the gas that flows there along, and the gaps between the hollow fiber membranes 11 cannot be increased to guide the gas to the central portions of the bundles of the hollow fiber membranes 11. When the average effective length L₃ of the hollow fiber membranes 11 is above the upper limit, the fiber membranes 11 can be excessively bent due to the weight of the hollow fiber membranes 11, and the filtration modules 1 cannot be easily handled when, for example, the filtration modules 1 are installed. The “average effective length of the hollow fiber membranes” is the length of the portions between the lower end of the first water collector 12 and the upper end of the second water collector 13 in the axial direction.

The lower limit of the ratio of the average effective length L₃ to the average outer diameter of the hollow fiber membranes 11 (aspect ratio) is preferably 150, and more preferably, 1000. The upper limit of the aspect ratio of the hollow fiber membranes 11 is preferably 6000, and more preferably, 5000. When the aspect ratio of the hollow fiber membranes 11 is below the lower limit, the hollow fiber membranes 11 cannot be sufficiently shook by the gas that flows there along and the gaps between the hollow fiber membranes 11 cannot be increased to guide the gas to the central portions of the bundles of the hollow fiber membranes 11. When the aspect ratio of the hollow fiber membranes 11 is above the upper limit, the hollow fiber membranes 11 can be excessively thin and long and the mechanical strength thereof can be reduced when the hollow fiber membranes 11 are vertically stretched.

The lower limit of the porosity of the hollow fiber membranes 11 is preferably 70%, and more preferably, 75%. The upper limit of the porosity of the hollow fiber membranes 11 is preferably 90%, and more preferably, 85%. When the porosity of the hollow fiber membranes 11 is below the lower limit, the water permeability can be reduced and the filtration performance of the filtration modules 1 can be reduced accordingly. When the porosity of the hollow fiber membranes 11 is above the upper limit, the mechanical strength and resistance to scrubbing of the hollow fiber membranes 11 can be insufficient. The porosity is the percentage of the total volume of the pores relative the volume of the hollow fiber membranes 11, and can be determined by measuring the density of the hollow fiber membranes 11 in accordance with ASTM-D-792.

The lower limit of the area-occupying percentage of the pores in the hollow fiber membranes 11 is preferably 40%. The upper limit of the area-occupying percentage of the pores in the hollow fiber membranes 11 is preferably 60%. When the area-occupying percentage of the pores is below the lower limit, the water permeability can be reduced and the filtration performance of the filtration modules 1 can be reduced accordingly. When the area-occupying percentage of the pores is above the upper limit, the surface strength of the hollow fiber membranes 11 can be insufficient and the hollow fiber membranes 11 can, for example, be damaged by the gas that flows there along. The “area-occupying percentage of the pores” is the percentage of the total area of the pores in the outer peripheral surfaces of the hollow fiber membranes 11 relative to the surface area of the hollow fiber membranes 11, and can be determined by analyzing an electron micrograph of the outer peripheral surfaces of the hollow fiber membranes 11.

The lower limit of the average diameter of the pores in the hollow fiber membranes 11 is preferably 0.01 μm. The upper limit of the average diameter of the pores in the hollow fiber membranes 11 is preferably 0.45 μm, and more preferably, 0.1 μm. When the average diameter of the pores in the hollow fiber membranes 11 is below the lower limit, the water permeability can be reduced. When the average diameter of the pores in the hollow fiber membranes 11 is above the upper limit, the impurities contained in the liquid to be treated cannot be appropriately prevented from permeating into the hollow fiber membranes 11. The average diameter of the pores is the average diameter of the pores in the outer peripheral surfaces of the hollow fiber membranes 11, and can be measured by using a pore diameter distribution measuring apparatus (for example, “automated pore diameter distribution measuring system for porous materials” manufactured by Porus Materials, Inc.).

The lower limit of the tensile strength of the hollow fiber membranes 11 is preferably 50 N, and more preferably, 60 N. When the tensile strength of the hollow fiber membranes 11 is below the lower limit, the durability against surface cleaning by bubbles can be reduced. The upper limit of the tensile strength of the hollow fiber membranes 11 is generally 150 N. The tensile strength is the maximum tensile stress applied in a tension test performed in accordance with JIS-K7161 (1994) at a gauge length of 100 mm and a test speed of 100 mm/min.

The hollow fiber membranes 11 preferably have a multilayer structure. For example, as illustrated in FIG. 5, each hollow fiber membrane 11 may include a cylindrical support layer 11a and a filtration layer 11b stacked on a surface (outer surface) of the support layer 11a. When the hollow fiber membranes 11 have a multilayer structure, high water permeability and high mechanical strength can both be achieved, and the surface cleaning effect of the gas can be increased.

The materials of the support layer 11a and the filtration layer 11b may have polytetrafluoroethylene (PTFE) as the main component. When the materials of the support layer 11a and the filtration layer 11b have PTFE as the main component, the hollow fiber membranes 11 have high mechanical strength and the surface thereof is not easily damaged, for example, by the gas that flows there along.

The lower limit of the number-average molecular weight of the PTFE contained in the support layer 11a and the filtration layer 11b is preferably 500,000, and more preferably, 2,000,000. The upper limit of the number-average molecular weight of the PTFE contained in the support layer 11a and the filtration layer 11b is preferably 20,000,000. When the number-average molecular weight of the PTFE is below the lower limit, the surfaces of the hollow fiber membranes 11 can be damaged by the gas that flows there along, and the mechanical strength of the hollow fiber membranes 11 can be reduced. When the number-average molecular weight of the PTFE is above the upper limit, it can be difficult to form the pores in the hollow fiber membranes 11.

An extrusion molded tube made of PTFE, for example, may be used as the support layer 11a. When an extrusion molded tube is used as the support layer 11a, the support layer 11a has high mechanical strength and pores can be easily formed therein. The tube is preferably stretched at a stretching ratio of 50% to 700% in the axial direction and a stretching ratio of 5% to 100% in the circumferential direction.

The stretching is preferably performed at a temperature that is lower than or equal to the melting point of the tube material, for example, at 0° C. to 300° C. The stretching is preferably performed at a low temperature when a porous body with a relatively large pore diameter is to be obtained, and is preferably performed at a high temperature when a porous body with a relatively small pore diameter is to be obtained. The stretched porous body is subjected to a heat treatment for 1 to 30 minutes, for example, at a temperature of 200° C. to 300° C. while both ends thereof are fixed so that the porous body is maintained stretched. As a result, the porous body has high dimensional stability. The size of the pores in the porous body can be adjusted by the combination of the conditions such as the stretching temperature and stretching ratio.

The tube that forms the support layer 11a may be obtained by, for example, blending PTFE fine powder with a liquid lubricant such as naphtha, forming the blend into a tubular shape by extrusion molding, and then performing stretching. The tube is baked for several tens of seconds to several minutes in a heating furnace maintained at a temperature that is higher than or equal to the melting point of the PTFE fine powder, for example, at 350° C. to 550° C., so that the dimensional stability thereof can be increased.

The average thickness of the support layer 11a is preferably 0.1 mm to 3 mm. When the average thickness of the support layer 11a is within the above-described range, a good balance can be achieved between the mechanical strength and water permeability of the hollow fiber membranes 11.

The filtration layer 11b may be formed by, for example, winding a PTFE sheet around the support layer 11a and baking the PTFE sheet. When a sheet is used as the material of the filtration layer 11b, stretching can be easily performed, and the shape and size of the pores can be easily adjusted. In addition, the thickness of the filtration layer 11b can be reduced. Furthermore, when the sheet is wound around the support layer 11a and baked, the support layer 11a and the filtration layer 11b are integrated and the pores therein are connected to each other, so that the water permeability can be increased. The baking temperature is preferably higher than or equal to the melting points of the tube that forms the support layer 11a and the sheet that forms the filtration layer 11b.

The sheet that forms the filtration layer 11b may be obtained by, for example, (1) a method of stretching a shaped body in an unbaked state, which is obtained by extruding a resin, at a temperature lower than or equal to the melting point and then performing baking; or (2) a method of stretching a shaped body made of a resin in a baked state after gradually cooling the shaped body to increase the crystallinity thereof. The sheet is preferably stretched at a stretching ratio of 50% to 1000% in the long-side direction and at a stretching ratio of 50% to 2500% in the short-side direction. In particular, when the stretching ratio in the short-side direction is in the above-described range, the mechanical strength in the circumferential direction can be increased when the sheet is wound, and the durability against surface cleaning by the gas can be increased.

In the case where the filtration layer 11b is formed by winding a sheet around a tube that forms the support layer 11a, the tube preferably has small irregularities on the outer peripheral surface thereof. When the tube has small irregularities on the outer peripheral surface thereof, a displacement between the tube and the sheet can be prevented, and the adhesion between the tube and the sheet can be increased so that the filtration layer 11b can be prevented from becoming separated from the support layer 11a due to cleaning by the gas. The number of times the sheet is wound may be adjusted in accordance with the thickness of the sheet, and may be one or more. Also, a plurality of sheets may be wound around the tube. The method for winding the sheet is not particularly limited. The sheet may be wound in the circumferential direction of the tube, or helically around the tube.

The size (height difference) of the small irregularities is preferably 20 μm to 200 μm.

The small irregularities are preferably formed over the entire region of the outer peripheral surface of the tube, but may instead be partially or non-continuously formed on the outer peripheral surface of the tube. The small irregularities may be formed on the outer peripheral surface of the tube by, for example, surface treatment by flames, laser irradiation, plasma irradiation, or dispersion coating of a fluorine based resin or the like. Preferably, the irregularities are formed by surface treatment by flames so that the irregularities can be easily foamed without influencing the characteristics of the tube.

The tube and the sheet may be prepared in an unbaked state, and baked after the sheet is wound around the tube. In such a case, the adhesion between the tube and the sheet can be increased.

The average thickness of the filtration layer 11b is preferably 5 μm to 100 μm. When the average thickness of the filtration layer 11b is within this range, hollow fiber membranes 11 having high filtration performance can be easily and reliably obtained.

### (First Water Collector)

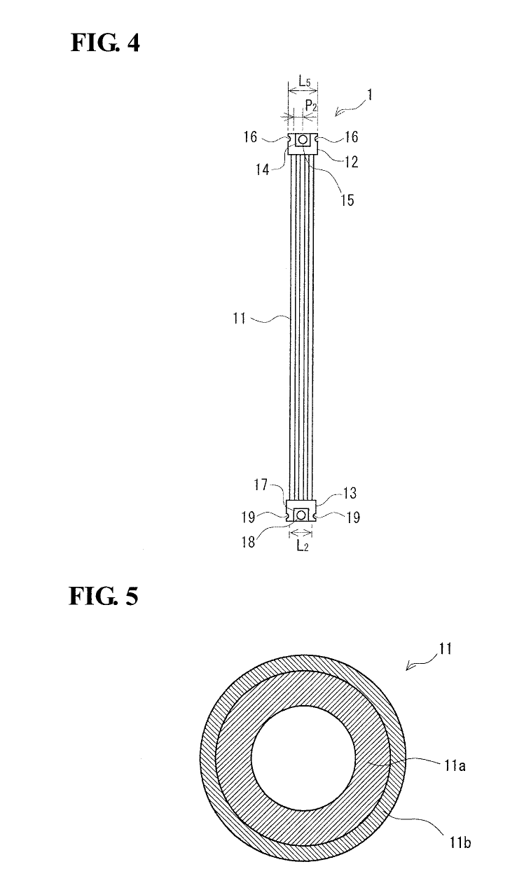

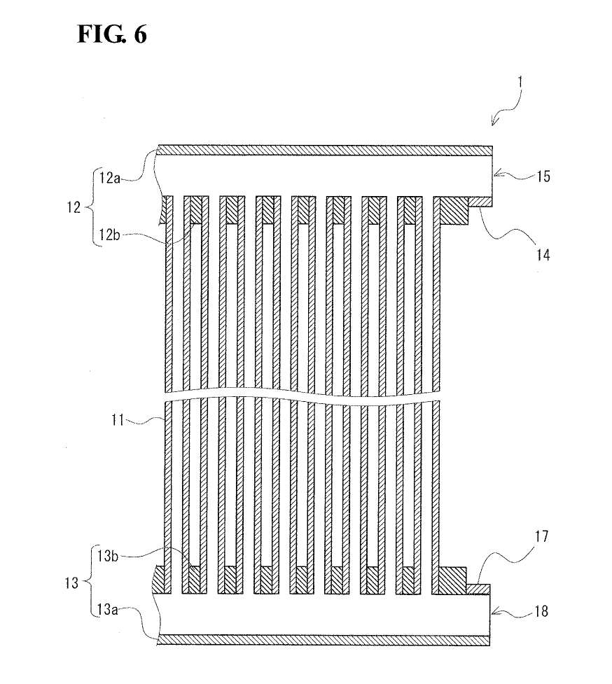

As illustrated in FIG. 6, the first water collector 12 includes a casing 12a that opens at the bottom and into which top end portions of the hollow fiber membranes 11 are inserted from below. The first water collector 12 also includes a resin composition 12b that fills the spaces between the casing 12a and the hollow fiber membranes 11 and the spaces between the hollow fiber membranes 11. More specifically, a bundle of hollow fiber membranes 11 obtained by bonding the top end portions of the hollow fiber membranes 11 with the resin composition 12b in advance is inserted into the casing 12a, and the spaces between the resin composition and the casing 12a or between the hollow fiber membranes 11 and the casing 12a are filled with additional resin composition 12b, so that the first water collector 12 is integrated with the hollow fiber membranes 11. The first water collector 12 also includes a projecting portion 14 that projects in the axial direction in an outer region thereof, and has an opening 15 in an outer end portion thereof. In addition, as illustrated in FIGS. 3 and 4, the first water collector 12 has a pair of recessed grooves 16 that are located so as to oppose each other in a horizontal direction with the central axis disposed therebetween and that extend in the axial direction. The first water collector 12 is sealed in regions other than the portions connected to the hollow fiber membranes 11 and the opening 15. The first water collector 12 is structured so that the filtered liquid that flows from the hollow fiber membranes 11 can be discharged from the opening 15.

The material of the casing 12a may be, for example, a resin composition having PTFE, vinyl chloride, polyethylene, ABS resin, etc., as the main component.

There is no particular limitation regarding the resin composition 12b as long as it is strongly adhesive to the hollow fiber membranes 11 and the casing 12a and is curable in the casing 12a. When, in particular, PTFE is used as the main component of the hollow fiber membranes 11, the main component of the resin composition 12b is preferably an epoxy resin or polyurethane, which are strongly adhesive to PTFE and capable of reliably preventing the hollow fiber membranes 11 from falling. Since the casing 12a is filled with the resin composition 12b, the spaces between the hollow fiber membranes 11 and the casing 12a can be sealed airtight, and the liquid to be treated that is not filtered can be prevented from entering and being mixed with the filtered liquid.

The length L₄ of a portion of the first water collector 12 excluding the projecting portion 14 in the long-side direction is greater than or equal to the average length L₁ of the presence region A in the long-side direction. The lower limit of the length L₄ in the long-side direction is preferably 400 mm, and more preferably, 600 mm. The upper limit of the length L₄ in the long-side direction is preferably 1300 mm, and more preferably, 1100 mm. When the length L₄ in the long-side direction is below the lower limit, a sufficient number of hollow fiber membranes 11 cannot be connected and sufficient filtration efficiency cannot be obtained. When the length L₄ in the long-side direction is above the upper limit, handling of the filtration modules 1 can be difficult.

The average width L₅ of the first water collector 12 (length in the short-side direction along a horizontal direction) is greater than or equal to the average length L₂ of the presence region A in the short-side direction. The lower limit of the average width L₅ of the first water collector 12 is preferably 15 mm, and more preferably, 20 mm. The upper limit of the average width L₅ of the first water collector 12 is preferably 110 mm, and more preferably, 85 mm. When the average width L₅ of the first water collector 12 is below the lower limit, a sufficient number of hollow fiber membranes 11 cannot be connected to the first water collector 12 and sufficient filtration efficiency cannot be obtained. When the average width L₅ of the first water collector 12 is above the upper limit, the gas ejected from the diffuser tubes 3 cannot be appropriately supplied to the central portions of the bundles of the hollow fiber membranes 11.

### (Second Water Collector)

As illustrated in FIG. 6, the second water collector 13 includes a casing 13a that opens at the top and into which bottom end portions of the hollow fiber membranes 11 are inserted from above. The second water collector 13 also includes a resin composition 13b that fills the spaces between the casing 13a and the hollow fiber membranes 11 and the spaces between the hollow fiber membranes 11. The second water collector 13 also includes a projecting portion 17 that projects in the axial direction in an outer region thereof, and has an opening 18 in an outer end portion thereof. In addition, as illustrated in FIGS. 3 and 4, the second water collector 13 has a pair of recessed grooves 19 that are located so as to oppose each other in a horizontal direction with the central axis disposed therebetween and that extend in the axial direction. More specifically, the second water collector 13 has a shape obtained by vertically inverting the first water collector 12. The material of the second water collector 13 is the same as the material of the first water collector 12.

Each filtration module 1 may include a connecting member for connecting the first water collector 12 and the second water collector 13 to facilitate handling (transportation, installation, replacement, etc.) thereof. The connecting member may be, for example, a support rod made of a metal or a casing (sheath) made of a resin.

### <Piping Unit>

As illustrated in FIG. 1, the piping unit 2 is connected to the first water collecting pipes 12 and the second water collecting pipes 13 of the filtration modules 1. The piping unit 2 includes a plurality of first connection pipes 2a that are connected to side walls of the outer end portions of the first water collectors 12 of the filtration modules 1 in each row; two combining pipes 2b that are arranged parallel to each other and that are connected to the outer end portions of the first water collectors 12 by the first connection pipes 2a; a plurality of second connection pipes 2c that are connected between the outer end portions of the first water collectors 12 and the second water collectors 13 of the filtration modules 1; and an extraction pipe 2d connected to the two combining pipes 2b.

The first connection pipes 2a have openings in inner portions of the peripheral walls thereof and are connected to the first water collectors 12 by fitting the projecting portions 14 of the first water collectors 12 into the openings. The second connection pipes 2c are bent in an L-shape at the bottom ends thereof, and are connected to the second water collectors 13 by fitting the projecting portions 17 of the second water collectors 13 into openings at the bottom ends thereof. The first connection pipes 2a and the second connection pipes 2c may be removably fitted to the first water collectors 12 and the second water collectors 13.

The lower limit of the average diameter (average outer diameter) of the first connection pipes 2a and the second connection pipes 2c is preferably 20 mm, and more preferably, 30 mm. The upper limit of the average diameter of the first connection pipes 2a and the second connection pipes 2c is preferably 60 mm, and more preferably, 50 mm. When the average diameter of the first connection pipes 2a and the second connection pipes 2c is below the lower limit, the filtered liquid cannot be efficiently discharged. When the average diameter of the first connection pipes 2a and the second connection pipes 2c is above the upper limit, the first connection pipes 2a and the second connection pipes 2c can be unnecessarily large.

The two combining pipes 2b are connected to the first connection pipes 2a at the peripheral walls thereof. The two combining pipes 2b are disposed near the right horizontal frame 6e and the left horizontal frame 6f in the upper section of the filtration unit and extend parallel to the right horizontal frame 6e and the left horizontal frame 6f. In other words, the two combining pipes 2b extend in the front-rear direction.

The lower limit of the average diameter (average outer diameter) of the combining pipes 2b is preferably 50 mm, and more preferably, 60 mm. The upper limit of the average diameter of the combining pipes 2b is preferably 180 mm, and more preferably, 160 mm. When the average diameter of the combining pipes 2b is below the lower limit, the filtered liquid cannot be efficiently discharged. When the average diameter of the combining pipes 2b is above the upper limit, the combining pipes 2b can be unnecessarily large.

The extraction pipe 2d is connected to ends of the two combining pipes 2b at the same side. Accordingly, the two combining pipes 2b and the extraction pipe 2d together form a U-shaped structure in plan view. The extraction pipe 2d has an opening 22 in a central portion thereof in the axial direction. The opening 22 in the extraction pipe 2d is connected to a discharge pipe (not shown), and the filtered liquid can be extracted through the discharge pipe. The average diameter of the extraction pipe 2d may be the same as the average diameter of the combining pipes 2b. Since the filtration unit includes the piping unit 2 including the extraction pipe 2d connected to the two combining pipes 2b, the structure for extracting the filtered liquid can be simplified and the efficiency thereof can be increased.

### <Diffuser Tubes>

As illustrated in FIG. 2, the diffuser tubes 3 are disposed below the filtration modules 1. The diffuser tubes 3 have a plurality of through holes from which gas is ejected. The diffuser tubes 3 extend parallel to the width direction of the filtration modules 1 (long-side direction of the above-described presence regions A). Each diffuser tube 3 is disposed so as to correspond to a gap between the filtration modules 1 that are adjacent to each other in the front-rear direction in each row, so that the gas can be ejected toward the gap between the filtration modules 1 that are adjacent to each other in the front-rear direction in each row.

The lower limit of the average diameter of the through holes is preferably 1 mm, and more preferably, 2 mm. The upper limit of the average diameter of the through holes is preferably 10 mm, and more preferably, 8 mm. When the average diameter of the through holes is below the lower limit, a sufficient amount of gas cannot be ejected. When the average diameter of the through holes is above the upper limit, excessive amount of gas is ejected from each through hole, and most of the gas supplied from one end of each diffuser tube 3 can be ejected from the through holes near that end of the diffuser tube 3 and the amount of gas ejected from the through holes near the other end of the diffuser tube 3 can be reduced.

The lower limit of the average diameter (average outer diameter) of the diffuser tubes 3 is preferably 10 mm, and more preferably, 15 mm. The upper limit of the average diameter of the diffuser tubes 3 is preferably 80 mm, and more preferably, 60 mm. When the average diameter of the diffuser tubes 3 is below the lower limit, a sufficient amount of gas cannot be ejected. When the average diameter of the diffuser tubes 3 is above the upper limit, it can be difficult to arrange each diffuser tube 3 so as to correspond to a gap between the filtration modules 1 that are adjacent to each other in each row.

### <Ventilation Mechanism>

The ventilation mechanism 4 force-feeds the gas to the diffuser tubes 3. As illustrated in FIG. 2, the ventilation mechanism 4 includes a supply pipe 24 connected to the diffuser tubes 3 and a gas supplying device (not shown) that supplies the gas to the supply pipe 24. The supply pipe 24 is substantially L-shaped. More specifically, the supply pipe 24 includes a vertical portion that extends in the vertical direction behind the filtration modules 1 and a horizontal portion that extends forward from the bottom end of the vertical portion. The horizontal portion of the supply pipe 24 is connected to the diffuser tubes 3. More specifically, the diffuser tubes 3 extend in a direction perpendicular to the axial direction of the horizontal portion and are connected to the horizontal portion.

### <Guide Structures>

The guide structures 5 are disposed between the diffuser tubes 3 and the filtration modules 1 and guide the gas ejected from the diffuser tubes 3 to the spaces between the filtration modules 1.

The guide structures 5 are configured to intermittently eject bubbles. The structure for intermittently ejecting bubbles may be, for example, a structure in which the gas supplied from the diffuser tubes 3 is temporarily stored and from which the gas is intermittently ejected when the volume thereof reaches a certain volume.

### <Cover>

The cover is a tubular body having a rectangular shape in cross section that covers the peripheral surface of the filtration unit in the vertical direction. The cover surrounds at least a portion of the filtration unit in the vertical direction. For example, the cover may be arranged so as to surround an upper portion of the filtration unit.

### [Advantages]

In the filtration unit, since the piping unit 2 is connected to the outer end portions of the first water collectors 12, the hollow fiber membranes 11 connected to portions of the first water collectors 12 near the outer end portions tend to have high operating ratios. Therefore, in the filtration unit, the hollow fiber membranes 11 connected to portions of the first water collectors 12 near the outer end portions are easily soiled. In this regard, since the hollow fiber membranes 11 that are easily soiled are arranged in the outer regions of the filtration modules in the filtration unit, the hollow fiber membranes 11 that are easily soiled can be easily cleaned even when the filtration modules 1 are installed in the filtration unit. Thus, the filtration unit enables the hollow fiber membranes 11 to be cleaned with increased efficiency.

In the filtration unit, the piping unit 2 includes the second connection pipes 2c that are connected between the outer end portions of the first water collectors 12 of the filtration modules 1 and the outer end portions of the second water collectors 13 of the filtration modules 1. Therefore, the filtered liquid can be extracted not only from the first water collectors 12 but also from the second water collectors 13, and the efficiency of the filtration process can be increased. In addition, in the filtration unit, since the second connection pipes 2c are also connected to the first water collectors 12, the filtered liquid collected by the second water collectors 13 can be extracted through the same path as the path through which the filtered liquid collected by the first water collectors 12 is extracted. Accordingly, the number of components can be reduced, so that the structure can be simplified and the cost can be reduced.

The filtration unit includes the diffuser tubes 3 that are disposed below the filtration modules 1 and that have the through holes from which gas is ejected, and the ventilation mechanism 4 that force-feeds the gas to the diffuser tubes 3. Accordingly, the impurities that adhere to the surfaces of the hollow fiber membranes 11 can be easily and reliably removed by the gas ejected from the diffuser tubes 3. As a result, the cleaning efficiency can be further increased.

The filtration unit includes the guide structures 5 that are disposed between the diffuser tubes 3 and the filtration modules 1 and guide the gas ejected from the diffuser tubes 3 to the spaces between the filtration modules 1. Therefore, the impurities that adhere to the surfaces of the hollow fiber membranes 11 can be more easily and reliably removed.

Since the filtration unit is structured such that the guide structures 5 intermittently eject bubbles, the impurities that adhere to the surfaces of the hollow fiber membranes 11 can be more efficiently removed.

Since the filtration unit includes the cover that surrounds the filtration unit in the vertical direction, the cleaning gas can be prevented from being dispersed as the gas flows upward. As a result, the impurities that adhere to the surfaces of the hollow fiber membranes 11 can be more easily and reliably removed.

### [Other Embodiments]

It is to be understood that the above-disclosed embodiment is an example and not restrictive in all respects. The scope of the present invention is not limited by the configuration of the above-described embodiment, and is defined by the claims. The present invention is intended to include equivalents to the scope of the claims and all modifications within the scope of the claims.

For example, it is not necessary that the filtration unit include the second water collectors having a linear shape that are connected to the lower openings of the hollow fiber membranes and the second connection pipes that are connected between the outer end portions of the first water collectors and the outer end portions of the second water collectors. The filtration unit may have a structure that includes neither the second water collectors nor the second connection pipes. For example, the second water collectors may be replaced by lower holding units that are connected to the bottom ends of the hollow fiber membranes and that do not have flow channels therein. Alternatively, the hollow fiber membranes 11 may each be bent in a U-shape, and a bending rod may be arranged at the bent portions of the hollow fiber membranes 11.

Even when the filtration unit includes the second water collectors, the second connection pipes connected to the second water collectors are not necessarily connected to the first connection pipes, and may instead be connected to the combining pipes independently of the first connection pipes.

In the filtration unit, the first water collectors and the second water collectors are not necessarily connected to the piping unit (first connection pipes and second connection pipes) at the side walls of the outer end portions in the axial direction, and may instead be connected to the piping unit at, for example, the upper walls of the outer end portions of the casings.

The filtration unit does not necessarily include the extraction pipe connected to the two combining pipes, and the filtered liquid may be extracted from each combining pipe individually. In addition, the extraction pipe is not necessarily connected to the ends of the two combining pipes, and may instead be connected to, for example, a central portion of each combining pipe in the axial direction.

The filtration unit does not necessarily include the diffuser tubes and the ventilation mechanism that force-feeds gas to the diffuser tubes. Even when the filtration unit is configured such that gas is ejected from below the filtration modules, a jet-type air-diffusing device that jets gas from a diffuser, a sparger, or the like or a bubbling jet nozzle that jets a mixture of water and bubbles, for example, may instead be used.

Even when the filtration unit is configured such that gas is ejected from below the filtration modules, it is not necessary that the guide structures that guide the gas to the spaces between the filtration modules be provided. In other words, the filtration unit may be configured such that the gas is directly ejected to the spaces between the filtration modules from the diffuser tubes or other devices.

Even when the filtration unit includes the above-described guide structures, the guide structures are not necessarily configured to eject bubbles intermittently, and may instead be configured to eject bubbles or gas continuously.

The filtration unit may be used as various types of filtration units such as an external-pressure type filtration unit in which the pressure is increased at the outer peripheral surfaces of the hollow fiber membranes so that the liquid to be treated permeates toward the inner peripheral surfaces of the hollow fiber membranes, and a submerged type filtration unit in which the liquid to be treated is caused to permeate toward the inner peripheral surfaces by an osmotic pressure or a negative pressure at the inner peripheral surfaces. In particular, the filtration unit is suitable for use as an external-pressure type filtration unit.

### INDUSTRIAL APPLICABILITY

As described above, the filtration unit according to the present invention enables the hollow fiber membranes to be cleaned with increased efficiently, and is suitable for use in various fields as a solid-liquid separation treatment apparatus.

### REFERENCE SIGNS LIST

1 filtration module

2 piping unit

2a first connection pipe

2b combining pipe

2c second connection pipe

2d extraction pipe

3 diffuser tube

4 ventilation mechanism

5 guide structure

6a front vertical frame

6b rear vertical frame

6c front horizontal frame

6d rear horizontal frame

6e right horizontal frame

6f left horizontal frame

6g support frame

6h module support frame

11 hollow fiber membrane

11a support layer

11b filtration layer

12 first water collector

12a casing

12b resin composition

13 second water collector

13a casing

13b resin composition

14, 17 projecting portion

15, 18, 22 opening

16, 19 recessed groove

24 supply pipe

1. A filtration unit comprising:
a plurality of filtration modules, each including a plurality of hollow fiber membranes extending in a vertical direction and arranged side by side in a form of a plate and a first water collector having a linear shape that is connected to upper openings of the hollow fiber membranes and through which filtered liquid that has permeated into each hollow fiber membrane flows; and
a piping unit connected to the first water collectors of the filtration modules,
wherein the filtration modules are arranged in two rows and in a striped pattern in each row, and
wherein the piping unit includes two combining pipes that are arranged parallel to each other and that are connected to outer end portions of the first water collectors of the filtration modules in each row by first connection pipes.

2. The filtration unit according to claim 1, wherein each filtration module includes a second water collector having a linear shape that is connected to lower openings of the hollow fiber membranes and through which the filtered liquid that has permeated into each hollow fiber membrane flows, and
wherein the piping unit includes a plurality of second connection pipes that are connected between the outer end portions of the first water collectors of the filtration modules and outer end portions of the second water collectors of the filtration module.

3. The filtration unit according to claim 1, wherein the piping unit includes an extraction pipe connected to the two combining pipes.

4. The filtration unit according to claim 1, comprising a plurality of diffuser tubes that are disposed below the filtration modules and that have a plurality of through holes from which gas is ejected, and a ventilation mechanism that force-feeds the gas to the diffuser tubes.

5. The filtration unit according to claim 4, comprising a plurality of guide structures that are disposed between the diffuser tubes and the filtration modules and that guide the gas ejected from the diffuser tubes to spaces between the filtration modules.

6. The filtration unit according to claim 5, wherein the guide structures are configured to intermittently eject bubbles.

7. The filtration unit according to claim 1, comprising a cover that surrounds the filtration unit in a vertical direction.
